(19) United States
(12) Patent Application Publication
(10) Pub. No.: US 2020/0093092 A1
(43) Pub. Date: Mar. 26, 2020

(54) MOVABLE AUTOMATIC FEEDING DEVICE, COMPANION ANIMAL CARE ROBOT, COMPANION ANIMAL CARE SYSTEM COMPRISING SAME, AND METHOD FOR CONTROLLING SAME

(71) Applicant: Su Han SOUG, Gimpo-si (KR)

(72) Inventor: Su Han SOUG, Gimpo-si (KR)

(21) Appl. No.: 16/467,404

(22) PCT Filed: Jun. 13, 2017
(86) PCT No.: PCT/KR2017/006132

§ 371 Date: Jun. 6, 2019

(30) Foreign Application Priority Data
Dec. 7, 2016 (KR) 10-2016-0165478

(51) Int. Cl. A01K 5/02; B25J 5/00; B25J 9/16; B25J 13/00; B25J 19/02; B25J 11/00

(52) U.S. Cl. CPC A01K 5/02; B25J 5/007; B25J 9/1669; A01K 5/0291; B25J 19/026; B25J 11/008; B25J 19/021; B25J 13/006

(57) ABSTRACT

A movable automatic feeding device according to an embodiment includes: a body to form an outer appearance which includes an upper housing and a lower housing; a terminal mounting unit formed in the upper housing; a first interface unit which is a wired port disposed near the terminal mounting unit; a moving module provided with wheels disposed on the bottom surface of the lower housing and a drive motor to rotate the wheels; a feeding module which includes a feed container disposed in the upper housing and a feed discharge unit to discharge feed stored in the feed container; and a battery to supply electric power to the moving module and the feeding module.

### TECHNICAL FIELD

The present invention relates to a movable automatic feeding device, a companion animal care robot, a companion animal care system including the same, and a control method of the same.

### BACKGROUND ART

As industrialization and increase in median income proceed, pet ownership continues to increase. In particular, in order to overcome problems of nutritional deficiency and overeating in pets, it is essential to feed a consistent amount of food in a timely manner. However, when all family members go out or are away from home for a long time due to vacation, etc. or if the dual-income couples breed pets, the pet may be left home alone, causing a feeding problem.

In order to solve such problems, a variety of studies on management of a pet through an automatic feeding device have been made from various angles, and such an automatic feeding device has been disclosed in many publications including, for example, Korean Patent Laid-Open Publication No. 10-2002-0083968 (“Automatic feeding device for pets”).

However, such a pet feeding device as described above simply feeds at a scheduled time along with a user's voice stored therein and provides only an image signal of the pet taken by the camera to the user outside the house. That is, it is impossible to play with the pet or provide a schedule specific to types and natures of the pet while the use was away, therefore, physical and mental health of the pet cannot be promoted.

In other words, if a pet is left alone for a long time, the pet may suffer adverse effects on mental health such as depression or memory disorder, just like humans. In this regard, currently-developed automatic feeding devices have difficult problems.

Focusing on this point, technological development has been recently made in relation to pet care robots, and Korean Patent Laid-Open Publication No. 10-2007-0134086 (‘pet care robot operating system and method’) has disclosed subject matters relevant to the same.

However, the above described prior art publications are merely a description of technical ideas and do not at all disclose the details of a problem arising when an animal management robot is actually manufactured and applied to control pets.

More particularly, the prior art including the above described prior art publications does not specify a shape, structure and/or essential configuration of the robot to manage pets, as well as arrangement or connection of such essential configurations.

Further, the prior art lacks development of applications relevant to essential motions or actions of a robot to be taken in response to animals when the robot is actually employed.

In order to implement the robot disclosed in the above prior art, a processor, memory and various sensor units are required, causing excessive manufacturing costs and poor sales.

On the other hand, with recently active development of smart hones, a smartphone replacement cycle is shortened, causing problems related to disposal of used smartphones.

### DISCLOSURE

### Technical Problem

Embodiments of the present invention have been proposed to solve the above problems, and an object of the present invention is to provide a movable automatic feeding device, a companion animal care robot and a companion animal care system including the same, each of which has an optimum shape and structure for managing companion animals, provides various applications for management of the companion animals and can be manufactured at a low cost, as well as a control method of the same.

### Technical Solution

A movable automatic feeding device according to an embodiment of the present invention may include: a body to form an outer appearance, which includes an upper housing and a lower housing; a terminal mounting unit formed in the upper housing; a first interface unit which is a wired port disposed near the terminal mount unit; a moving module provided with a wheel disposed on the bottom surface of the lower housing and a drive motor to rotate the wheel; a feeding module which includes feed container disposed in the upper housing and a feed discharge unit to discharge feed stored in the feed container; and a battery to supply electric power to the moving module and the feeding module.

Further, a companion animal care robot according to an embodiment of the present invention may include: a body to form an outer appearance; a terminal mounting unit formed on the body to support a terminal mounted thereon (‘mounted terminal’); a first interface unit enabling wired communication with the terminal; a moving module to move the body; a feeding module to discharge feed to the outside of the body; a sensor unit to sense a distance between the body and an object located around the body; and a battery to supply electric power to the feeding module and the sensor unit.

Further, a companion animal care system according an embodiment of the present invention may include: a companion animal care robot which includes a terminal mounting unit to support a mounted terminal, a sensor unit to sense an object located around the robot, a moving module having a wheel and a drive motor to rotate the wheel, a feeding module to discharge feed, and a first interface unit for data communication with the mounted terminal; and the mounted terminal which includes a second interface unit for data communication with the companion animal care robot, a camera unit to take pictures around the robot, and a processor that generates robot control signals to control the moving module and the feeding module while transmitting the generated signals through the second interface unit.

Still further, a method for controlling a companion animal care robot system according to an embodiment of the present invention may include: sensing a distance to surrounding animals by a sensor unit in a companion animal care robot; receiving information in regard to the distance to surrounding objects in amounted terminal; calculating a location of the animal from the distance information by the mounted terminal; moving the companion animal care robot to the calculated location of the animal depending on control by the mounted terminal; when a distance between the companion animal care robot and the location of the animal is within a predetermined range, dropping feed by the companion animal care robot; after dropping the feed, reversing the companion animal care robot to a preset distance; after reversing, photographing the front side to acquire a front image by the companion animal care robot; and transmitting the acquired front image to a user terminal.

### Advantageous Effects

The movable automatic feeding device according to the embodiment may have an optimum shape and structure to endure contact or collision/impact of the companion animal.

Further, the companion animal care robot according to the embodiment may be used in conjunction with the mounted terminal wherein an application for companion animal care is installed so that the companion animal care robot does not require any processor or camera with high production costs, thereby being manufactured at a low cost.

Further, the companion animal care system according to the embodiment may be configured by fitting the mounted terminal on the terminal mounting unit in the companion animal care robot and then forming an interface with units in the companion animal care robot through wired communication, while controlling units of the mounted terminal, thereby fulfilling different functions for companion animal care.

More particularly, the companion animal care system may fulfill an animal tracking function of searching for a location of the companion animal by analyzing sensor data and/or image information and then controlling the companion animal care robot to move to the searched location.

Further, the companion animal care system may fulfill an automatic feeding function of dispensing feed by controlling the feeding module after tracking the animal and moving backward to facilitate intake of food by the companion animal.

In addition of the automatic feeding function, the companion animal care system may fulfill a remote (companion animal) observation function of photographing feed intake at a proper location and transmitting the photographed image to a user terminal, so that the user can check on the companion animal having feed intake.

Further, the companion animal care system may fulfill a function of displaying video images of the user and further providing a video call function with a user terminal, in order to facilitate companion animal care.

Further, the companion animal care system may fulfill a remote robot control function of controlling the companion animal care robot based on remote control signals received from the user terminal.

### DESCRIPTION OF DRAWINGS

FIG. 1 illustrates a companion animal care system according to an embodiment of the present invention.

FIG. 2 is a block diagram of a companion animal care robot according to an embodiment of the present invention.

FIG. 3 is a perspective view of the companion animal care robot according to the embodiment of the present invention.

FIG. 4 illustrates the inside of a lower housing in the companion animal care robot according to the embodiment of the present invention.

FIG. 5 is an internal block diagram of a terminal mounted in the companion animal care robot according to an embodiment of the present invention.

FIG. 6 is a flowchart illustrating a control method of the companion animal care system according to an embodiment of the present invention.

FIG. 7 illustrates a process of dispensing feed by the companion animal care robot according to an embodiment of the present invention.

FIGS. 8 to 10 illustrate an example of the control of the companion animal care robot after dispensing the feed according to an embodiment the present invention.

### BEST MODE

On the understanding that the present invention may include diverse modifications and a variety of embodiments, specific embodiments will be illustrated in the drawings and described in detail by the following description. Functional effects and characteristics of the present invention, as well as a method for accomplishing the same, will be obviously understood from the embodiments specifically stipulated later along with the accompanying drawings. However, the present invention is not restricted to such specific embodiments but may be implemented in diverse forms. In the following embodiments, the terms ‘first’ and ‘second’ are not intended to restrict the present invention but merely used to distinguish one component from another component. Further, expressions in singular number may also include a plural form unless context clearly indicates otherwise. Further, the terms ‘include’ and ‘have’ are used to define the presence of features or components described in the specification, however, are not intended to preclude the possible presence or addition of one or more other features or components. Further, for convenient explanation, the components in the drawings may be enlarged or reduced in size. For instance, the size and thickness of each component in the drawings are randomly defined for convenient explanation, and therefore, the present invention is not duly limited to the definition illustrated in the drawings.

Hereinafter, embodiments of the present invention will be described in detail with reference to the accompanying drawings. In the following description with reference to the accompanying drawings, the same or corresponding components are defined by the same numerals and redundant explanation thereof will be omitted.

[symbol]

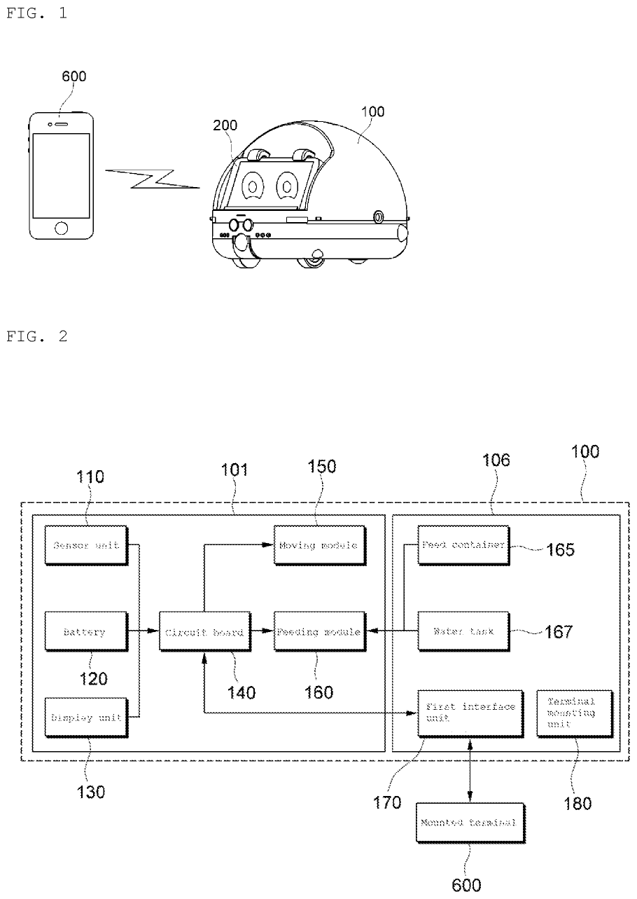

FIG. 1 illustrates a companion animal care system according to an embodiment of the present invention

Referring to FIG. 1, the companion animal care system according to the embodiment may include a companion animal care robot 100 and a terminal 200 mounted in the care robot 100 (referred to as ‘mounted terminal’), and may further include a user terminal 600 for wireless communication with the mounted terminal 200.

First, the companion animal care robot 100 in the embodiment may include a body to form an outer appearance, a moving module provided on the body which allows the robot to move by self-power, and a feeding module installed inside to supply feed to a companion animal.

Herein, the companion animal care robot 100 may be called a movable automatic feeding device due to being movable and supplying feed to the companion animal, and may be also referred to an infant care robot since it can take care of infants as well as companion animals. Hereinafter, for convenience of description, this device may be defined by a companion animal care robot 100 without particular limitation of embodiments thereof.

The companion animal care robot 100 has possibility of contact and collision while managing a companion animal and thus may have an optimum shape and structure to endure such impact or shock.

Further, the companion animal care robot 100 according to the embodiment may be driven in conjunction with the mounted terminal 200 having an application for companion animal care installed therein. Therefore, the care robot 100 itself does not require a processor, camera, etc. with high production costs, thus being manufactured at a low cost.

The mounted terminal 200 installed in the companion animal care robot 100 to control the same may correspond to, for example, a cellular phone, a smartphone, a tablet PC, a laptop computer, a digital broadcast terminal, a personal digital assistant (PDA), a portable multimedia player (PMP), etc. This mounted terminal 200 may have a program for controlling the care robot 100 installed therein.

In the embodiment, the mounted terminal 200 may be a smartphone in which a companion animal care application is installed by downloading the same from a server operated by a provider of the companion animal care robot 100.

The mounted terminal 200 may be fitted in a terminal mounting unit of the companion animal care robot 100 and interfaced with units of the same 100 through wired communication while controlling units of the mounted terminal 200, thereby fulfilling various functions for companion animal care.

For instance, the mounted terminal 200 may fulfill an animal tracking function of searching for a location of a companion animal by analyzing sensor data and/or image information and controlling the companion animal care robot 100 to move the animal to the location.

Further, the mounted terminal 200 may fulfill an automatic feeding function of dispensing feed by controlling the feeding module after tracking the animal and then moving backward to facilitate intake of food by the companion animal.

In addition to the automatic feeding function, the mounted terminal 200 may fulfill a remote (companion animal) observation function of photographing feed intake appearance at a proper location and transmitting the photographed image to a user terminal, so that the user can check on the companion animal having feed intake.

Further, the mounted terminal 200 may fulfill a function of displaying video images of the user and even providing a video call function with the user terminal 600, in order to facilitate companion animal care.

Further, the mounted terminal 200 may fulfill a remote robot control function of controlling the companion animal care robot 100 based on the remote control signals received from the user terminal.

The user terminal 600 communicating with the mounted terminal 200 may be a smartphone registered with the mounted terminal 200, wherein a companion animal care application is installed downloading the same from a server operated by a provider of the companion animal care robot 100.

Similar to the mounted terminal 200, the user terminal 600 may also correspond to, for example, a cellular phone, a smartphone, a tablet PC, a digital broadcasting terminal, a personal digital assistant (PDA), a portable multimedia player (PMP), etc.

In other words, the companion animal care system according to the embodiment may provide an optimum robot shape and structure to communicate with a companion animal and be used in conjunction with a smartphone, and may utilize any extra smartphone of the user to fulfill various functions for companion animal care so as reduce a production cost of the companion animal care robot 100 and recycle used smartphones for disposal, thereby having an advantage of being environmentally friendly.

[symbol]

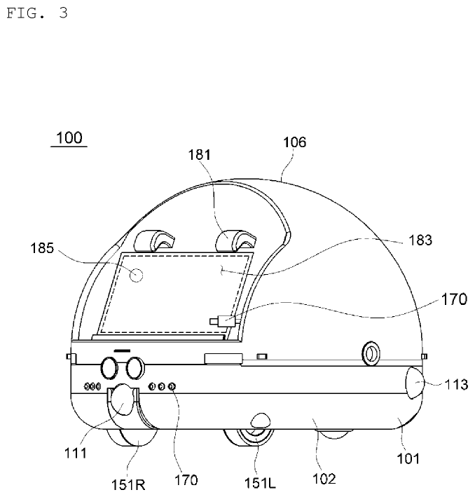

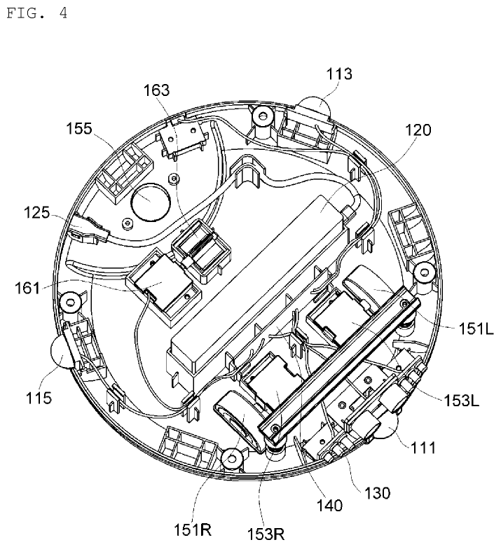

FIG. 2 is a block diagram of a companion animal care robot 100 according to an embodiment of the present invention; FIG. 3 is a perspective view of the companion animal care robot 100 according to the embodiment of the present invention; and FIG. 4 illustrates the inside of a lower housing in the companion animal care robot 100 according to the embodiment of the present invention.

Referring to FIGS. 2 to 4, the companion animal care robot 100 will be described in more detail.

Referring to FIG. 2, the companion animal care robot 100 according to the embodiment may include: a sensor unit 110; a battery 120; a display unit 130; a circuit board 140; a moving module 150; a feeding module 160; a feed container 165; a water tank 167; a first interface unit 170; and a terminal mounting unit 180. However, the units in the companion animal care robot 100 illustrated in FIG. 2 are not essential in implementing the companion animal care robot 100. Therefore, the companion animal care robot 100 described in the present specification may include many more or fewer components than the components listed above.

More particularly, the companion animal care robot 100 may include a body to form an outer appearance, and the body may be composed of an upper housing 106 and a lower housing 101 detachably combined with each other.

The upper housing 106 is formed in a cover shape with a curved surface having a space therein, and a bottom surface of the upper housing may be open. According to the embodiment, the upper housing 106 may have a hemispherical shape. Herein, the hemispherical shape may be a hemispherical shape having a cross-section in a circular, elliptical or distorted circular form.

That is, the outer appearance of the upper housing 106 according to the embodiment has a hemispherical shape consisting of a curved surface, and therefore, may spill out or disperse impact caused by physical contact of the animal.

In the embodiment, the lower housing 101 may be disposed on the open bottom surface of the upper housing 106 and may have a disk type cover shape with an inner space.

A lower edge 102 at a lateral side of the lower housing 101 is bent to the bottom and may be formed in a round shape. More particularly, the lower edge 102 of the lower housing 101 is formed in a round shape so as to prevent the feet of a companion animal from entering between the lower housing 101 and the ground and accidents from happening if the companion animal collides into the edge.

When implementing the automatic feeding function, the feed is supplied to a lower part of the companion animal care robot 100. During feeding, the companion animal may sniff the feed and sometimes put the feet between the companion animal care robot 100 and the ground in order to overturn the companion animal care robot 100. In this case, if the feet of the companion animal enter between the companion animal care robot 100 and the ground or lift upward after entering, the animal may slip on the rounded edge and a force of the feet of the animal may be distributed in a horizontal direction, so that the companion animal care robot 100 may be pushed back without falling over.

In other words, the appearance of the companion animal care robot 100 may have a design specific to companion animals, such that impact is dispersed to minimize damage from the outside and the companion animal care robot can stably maintain balance without being turned over in spite of different actions of the companion animal.

On the other hand, the upper housing 106 may be provided with a terminal mounting unit 180 to fix terminal.

In the embodiment, the terminal mounting unit 180 may include a support surface 183 to support the mounted terminal 200; and a fixing member 181 to secure the terminal disposed on the support surface 183. Further, the terminal mounting unit 180 may further include a tilt control member (not shown) to adjust inclination of the support surface 183; and a thru-hole lens 185 to observe the inside of the upper housing 106.

More particularly, the support surface 183 may be a flat surface formed by concavely carving a portion of the outer surface in a hemispherical shape. The support surface 183 may become tilted inside the upper housing 106 and formed as an inclined surface, so as to stably support the mounted terminal 200.

Further, the support surface 183 may include at least one fixing member 181 protruding outward in order to secure the mounted terminal 200. The fixing member 181 may have a bent protrusion shape in order to secure the lateral side and the top surface of the terminal, simultaneously. Further, in order to support separate terminals having different sizes, the fixing member 181 may be configured to move up and down (that is, vertically).

Further, the support surface 183 may include a tilt control member to adjust an angle of inclination (‘tilt angle’) of the support surface 183. More particularly, the support surface 183 may be separated from the upper housing 106, and the tilt control member may rotate a support member to support the separated support surface 183, thereby adjusting a tilt angle of the support surface 183 and, at the same time, controlling a slope of the mounted terminal.

That is, the tilt control member may adjust a tilt angle of the support surface 183 to thus alter a slope of the mounted terminal, thereby changing a photographing direction of a camera in the mounted terminal 200.

Further, the support surface 183 may be provided with a thru-hole lens 185 (or a mirror) passing through the support surface 183. Specifically, the thru-hole lens 185 may be disposed at a position of the support surface 183 corresponding to a rear camera in the mounted terminal 200 such that the rear camera can photograph the inside of the upper housing 106. Accordingly, it is possible to take pictures of a feed container 165 and/or a water tank 167 disposed inside the upper housing 106 by the rear camera in the mounted terminal 200. Therefore, a user can check an amount of the feed stored in the feed container from images taken by the rear camera (‘rear camera image’) without opening a cover of the feed container 165. Moreover, the user terminal 600 may be configured to receive the rear camera image from the mounted terminal 200 and determine the amount of stored feed.

Meanwhile, a first interface unit 170 may be arranged near the terminal mounting unit 180.

The first interface unit 170 may serve as a passage to the mounted terminal 200. More particularly, the first interface unit 170 is connected to a second interface unit of the mounted terminal 200 via wires to transmit electric energy from a battery 120 to the mounted terminal 200, and may receive a control signal for the companion animal care robot from the mounted terminal 200.

According to an embodiment, the first interface unit 170 may be a wired port (i.e., a plug) possibly connected to the second interface unit of the mounted terminal 200. For instance, the first interface unit 170 may be a wired type port such as an integrated standard 24-pin port, a 20-pin port, a USB port, a micro-USB 5-pin port, an iPhone 8 pin lightning port and USB type-C, etc. According to an embodiment, wireless interface connection is also possible. However, the mounted terminal 200 and the companion animal care robot 100 should transmit/receive electric power as well as data through the first interface unit 170, and therefore, it is preferable to implement a wired USB type interface unit.

Such a first interface unit 170 may have connection wires for connection with various units of the companion animal care robot 100 and a terminal (or port) for connection with the mounted terminal 200.

The connection wire may pass from the inside to the outside of the upper housing 106 through an opening formed in the terminal mounting unit 180 or near the same, and a terminal possibly connected with a port of the mounted terminal 200 to the outside may be provided at one end of the connection wire passing through the upper housing.

The first interface unit 170 may enable electric connection between the units of the companion animal care robot 100 and the mounted terminal 200, thereby serving as a channel for data exchange. Further, the first interface unit 170 is connected to the battery 120 and may transmit power of the battery 120 to the mounted terminal 200.

For this purpose, the first interface unit 170 may be directly and/or indirectly connected with the sensor unit 110, the battery 120, the display unit 130, the moving module 150 and the feeding module 160 through a circuit board 140.

According to an embodiment, the connection wire in the first interface unit 170 may be connected to the circuit 140, and electric wires branched from the circuit board 140 may be connected to the sensor unit 110, the display unit 130, the battery 120, the moving module 150 and the feeding module 160, respectively.

First, the circuit board 140 may gather distance information collected from the sensor unit 110 and transmit the same to the mounted terminal 200 via the first interface unit 170.

More particularly, the sensor unit 110 may be a distance sensor to collect information in regard to objects and distance around the companion animal care robot 100.

According to an embodiment, the sensor unit 110 may include three ultrasonic sensors arranged at equal intervals along an outer periphery of the lower housing 101. More particularly, with reference to a first ultrasonic sensor 111, a second ultrasonic sensor 113 may be disposed at one side of the first ultrasonic sensor with 120-degree interval while a third ultrasonic sensor 115 may be disposed at the other side with 120-degree interval.

The first to third ultrasonic sensors 111, 113 and 115 arranged above may sense all directions around the companion animal care robot 100.

On the basis of the distance information between the companion animal care robot 100 and the object sensed by the ultrasonic sensors 111, 113 and 115, the mounted terminal 200 may detect motion (movement of the animal) around the companion animal care robot 100 and thus fulfill an animal tracking function of tracking a location of an animal through motion detection.

Further, the mounted terminal 200 may control the moving module 150 to abruptly stop the companion animal care robot 100 when an object is found within a predetermined distance in a movement direction of the companion animal care robot 100, on the basis of the distance information between the companion animal care robot 100 and the object sensed by the ultrasonic sensors 111, 113 and 115.

For this purpose, the circuit board 140 receives signals for controlling the companion animal care robot transmitted from the mounted terminal 200 and then selectively transmits the control signals to the display unit 130, the moving module 150 and the feeding module 160, so that the mounted terminal 200 can control various units of the companion animal care robot 100.

First, the display unit 130 may be a light emitting element for converting an electrical signal into an optical signal, preferably, an LED (Light Emitting Diode). The display unit 130 may display control state, operating state, etc. of the companion animal care robot 100 by flashing or light emission.

Next, the moving module 150 may include a drive motor and wheels disposed in the lower housing 101 to thus move the companion animal care robot 100.

More particularly, the moving module 150 includes a left wheel 151L and a right wheel 151R, which protrude to the bottom of the companion animal care robot 100, and may further include a left drive motor 153L for driving the left wheel 151L and a right drive motor 153R for driving the right wheel 151R. In addition, the moving module 150 may include a rotatable ball 155 capable of rotating 360 degrees while supporting the companion animal care robot 100 along with both the left wheel 151L and the right wheel 151R.

The moving module 150 has a configuration of a separate left drive motor 153L and right drive motor 153R in the left wheel 151L and the right wheel 151R, respectively, in order to rotate both wheels in different directions and at different rates, and may include a 360-degree rotatable ball 155 to move the companion animal care robot 100 full 360 degrees in all directions.

The mounted terminal 200 may transmit a companion animal care robot control signal in order to control the rotational direction and speed of each of the left and right drive motors 153L and 153R, thereby moving the companion animal care robot 100 in a desired direction.

Next, the feeding module 160 may include a rotary motor 161 and a feed discharge unit 163 rotating by the rotary motor 161 in order to discharge the feed.

More particularly, the feed discharge unit 163 is disposed at a feed outlet provided on the bottom surface of the lower housing 101, in order to dispense a predetermined amount of feed stored in the feed container 165 and drop the feed below the bottom surface of the companion animal care robot 100 through the feed outlet. Therefore, the mounted terminal 200 may transmit a control signal for driving the rotary motor 161 through the first interface unit 170, thereby discharging the feed out of the companion animal care robot 100.

Although not shown, according to another embodiment, the feed outlet in the lower housing 101 may be disposed at the terminal mounting unit side 180 (e.g., in front of the companion animal care robot 100). That is, the terminal mounting unit 180 may be present at the front of the companion animal care robot 100, and the front side of the companion animal car robot 100 may directly face the animal during animal tracking. Therefore, the feed outlet should be placed on the bottom surface around the front side of the companion animal care robot 100 in order to drop the feed toward the animal.

With such a structure as described above, the feed may be dispensed toward the animal and, even when the companion animal care robot 100 moves backward by only a short distance, the feed dropped below the companion animal care robot 100 may be exposed toward the animal. Accordingly, it is possible to minimize a time of accessing and impacting the companion animal care robot 100 by the animal during feeding.

[symbol]

Further, the battery 120 including a socket (or port) 125 connected to an external power source may store electric power received from the external power source.

Further, the battery 120 may supply the electric power to the moving module 150, the feeding unit 160, the display unit 130, etc. according to a control signal from the mounted terminal 200.

Further, the battery 120 may also charge another battery 120 of the mounted terminal 200 through the first interface unit 170.

That is, the companion animal care robot 100 according to the embodiment has a configuration in which the battery 120 is directly connected to the mounted terminal 200 through the interface unit, so as to charge a power supply unit of the mounted terminal 200 by charging the battery 120 of the companion animal care robot 100 without separately charging the mounted terminal 200.

[symbol]

Meanwhile, the upper housing 106 may further be provided with a feed container 165 and/or a water tank 167.

A body of the feed container 165 may be disposed on the upper housing 106 while a feed discharge port of the feed container may be coupled to the feed outlet of the lower housing 101. In order to fill the feed container 165 with feed, the top of the feed container 165 is connected to the upper housing 106, wherein an open/closable cover may be mounted at the connected portion.

Further, a support member to support the body of the feed container 165 may be placed in the lower housing 101 in order to disperse a weight of the feed container 165 to the lower housing 101.

A structure of the water tank 167 is substantially the same as the feed container 165, and therefore, the description thereof will be replaced by the description for the feed container 165.

[symbol]

Like the support member of the feed container 165, most of the components in the companion animal care robot 100 described above may also be provided in the lower housing 101.

More particularly, according to an embodiment, the lower housing 101 may include a sensor unit 110, a battery 120, a display unit 130, a circuit board 140, a moving module 150, a feeding unit 160 and a support member for a feed container 165.

Therefore, the center of gravity of the companion animal care robot 100 is positioned in the lower housing 101 and thus may have a stable configuration remaining upright despite impact by the animal without being turned over.

In other words, the companion animal care robot 100 according to the embodiment may include a hemispherical upper housing 106 and a hemispherical lower housing 101, as well as the center of gravity formed in the lower housing 101, thereby having a stable structure that can withstand impact by an animal.

[symbol]

On the other hand, as described above, the companion animal care robot 100 may be combined with the mounted terminal 200 through the interface unit to thus configure a companion animal care system, and therefore, may fulfill a variety of functions for companion animals.

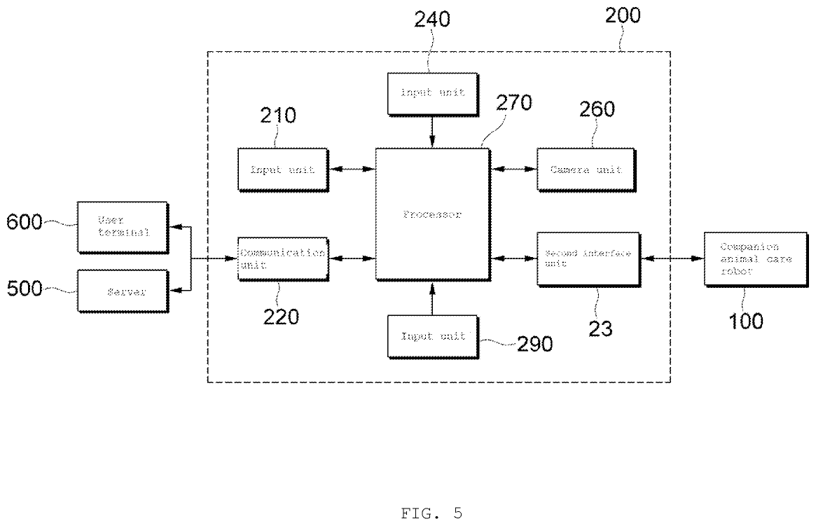

FIG. 5 is an internal block diagram illustrating the terminal 200 mounted in the companion animal care robot 100 according to the embodiment of the present invention.

Hereinafter, with respect to the mounted terminal 200 in which an application for controlling the companion animal care robot 100 is installed, the following description will be given.

Referring to FIG. 5, the mounted terminal 200 according to the embodiment may include an input unit 210, a communication unit 220, a second interface unit 230, a memory 240, a camera 260, a processor 270 and a power supply 290. However, the units of the mounted terminal 200 shown in FIG. 5 are not essential in implementing the mounted terminal 200, instead, the mounted terminal 200 described in the present specification may include many more or fewer components than the components listed above.

First, the input unit 210 may include an input member 210 to sense input by the user. For instance, the input unit 210 may sense input for turning the power supply of the mounted terminal 200 on/off, input for turning animal care functions of the mounted terminal 200 on/off, input for setting various details, etc.

The input unit 210 may include at least one among a gesture input unit for detecting a user gesture (e.g. optical sensor, etc.), a touch input unit for sensing touch (e.g., touch sensor, touch key, mechanical key, etc.), a user terminal 600, a microphone to sense user voice input and a remote controller, and a mobile terminal, thereby detecting user input.

[symbol]

Further, the mounted terminal 200 may include a communication unit 220 for wireless communication with the user terminal.

According to an embodiment, the communication unit 220 may transmit a front image and rear image taken by the camera unit 260 and voice recorded in the microphone to the user terminal 600. On the contrary, the communication unit 200 may further receive video images and voice from the user terminal 600.

Further, according to the embodiment, the communication unit 220 may receive a remote control signal for the companion animal care robot input by the user through the user terminal, while the processor 270 may transmit the received remote control signal for the companion animal care robot to the companion animal care robot 100 through the second interface unit 230 in order to implement a remote control function, so that the user can conduct remote control of the companion animal care robot 100.

The communication unit 220 may exchange data with the user terminal 600 in a wireless communication manner. Such wireless data communication may include a variety of data communication methods such as Bluetooth, Wi-Fi, Wi-Fi direct, APiX, LTE or NFC.

[symbol]

Next, the mounted terminal 200 may include the second interface unit 230 that receives/transmits data relevant to the companion animal care robot 100 from/to the companion animal care robot 100, or transmits signals processed or generated in the processor 270 to the companion animal care robot 100. Further, the mounted terminal 200 may receive the power supplied from the battery 120 of the companion animal care robot 100 through the second interface unit 230. That is, the mounted terminal 200 may perform data communication for controlling the companion animal care robot through the second interface unit 230, and also receive/transmit the electric power energy.

According to an embodiment, the second interface unit 230 may be connected with the first interface unit 170 of the companion animal care robot 100 by wires. For instance, the second interface unit 230 may be a wired type port such as an integrated standard 24-pin port, a 20-pin port, a USB port, a micro-USB 5 pin port, an iPhone 8 pin lightning port, USB type-C, etc. According to an embodiment, wireless interface connection is also possible. However, the mounted terminal 200 and the companion animal care robot 100 should transmit/receive electric power as well as data through the interface unit, and therefore, it will be preferable to implement a wired USB type interface unit.

[symbol]

Further, the mounted terminal 200 may include a memory 240 wherein the memory 240 can store various data for overall operation of the mounted terminal 200 such as a program in the processor 270 in regard to processing or control functions thereof.

Further, the memory 240 may store a number of application programs or applications driven in the mounted terminal 200, data and/or instructions for operation of the mounted terminal 200, etc. Further, such application programs may be stored in the memory 240 and driven by the processor 270 to implement the operation (or functions) of the mounted terminal 200.

According to an embodiment, the memory 240 may store data for identifying objects contained in images of the camera unit 260. For instance, if a predetermined object is detected in the image gained by the camera, the memory 240 can store data for determining what types the object corresponds to with a predetermined algorithm.

For instance, when an image obtained through a camera includes a specific object such as the appearance of a companion animal, an unique graphical image displayed on the collar of the companion animal, etc., the memory 240 may store data for identifying whether the object indicates the companion animal with a specific algorithm.

Further, the memory 240 may store video/voice input in the camera and microphone. More particularly, the memory 240 may classify and separately store video/voice input by the user in order to train a companion animal according to types of training information. For instance, video/voice for stopping an animal, video/voice for sitting down an animal, video/voice for playing with an animal, video/voice for allowing food intake by an animal, etc. may be each stored in the memory, and the processor 270 may extract the desired video/voice from the memory 240 and output the same to the companion animal via the display unit and the audio output unit, thereby controlling the animal.

[symbol]

Further, the mounted terminal 200 may include a power supply 290, and the power supply 290 can supply the power required for operation of each component under the control of the processer 270. The power supply 290 may be the battery 120 inside the mounted terminal 200.

[symbol]

Next, the mounted terminal 200 may include a camera unit 260 to take pictures around the companion animal care robot 100.

According to an embodiment, the camera unit 260 may include a front camera to photograph the front side of the mounted terminal 200, and a rear camera to photograph the backside of the same.

More particularly, the front camera may be operated by the processor 270 during execution of an animal tracking function, an automatic feeding function, a video call function, etc., so as to provide front images.

Further, the rear camera may photograph the feed container 165 inside the upper housing 106 and acquire rear images in order to check a feed amount.

The camera may include an image sensor and an image processing module. The camera may process static images or video acquired by the image sensor (e.g., CMOS or CCD). The image processing module may extract required information by processing the static images or video acquired by the image sensor, and then, transfer the extracted information to the processor 270.

[symbol]

Further, the mounted terminal 200 may include a display unit (not shown) displaying animal care-related images.

More particularly, the display unit may include at least one among a liquid crystal display (LCD), a thin film transistor liquid crystal display (TFT LCD), organic light emitting diodes (OLED), a flexible display, a three- dimensional display (3D display) and an electronic ink display (e-ink display).

Such a display unit as described above may be coupled to a touch input unit 210 to complete a touchscreen.

In addition, the mounted terminal 200 may further include an audio output unit.

The audio output unit may output sound associated with the animal care functions.

[symbol]

Finally, the mounted terminal 200 may include the processor 270 which controls overall operation of the units in the mounted terminal 200.

Such a processor 270 as described above may be embodied by at least one among application specific integrated circuits (ASICs), digital signal processors (DSPs), digital signal processing devices (DSPDs), programmable logic devices (PLDs), field programmable gate arrays (FPGAs), controllers, micro-electrical units for the controller (microcontrollers), microprocessors and other functions.

[symbol]

Hereinafter, a process of configuring a companion animal care system such that the mounted terminal 200 is interfaced with the companion animal care robot 100, and then, fulfilling animal care functions, will be described in detail below.

More particularly, the companion animal care system may include the companion animal care robot 100 and the terminal 200 mounted on the terminal mounting unit 180 of the companion animal care robot 100, wherein the second interface unit 230 of the mounted terminal 200 is connected with the first interface unit 170 of the companion animal care robot 100 by wires.

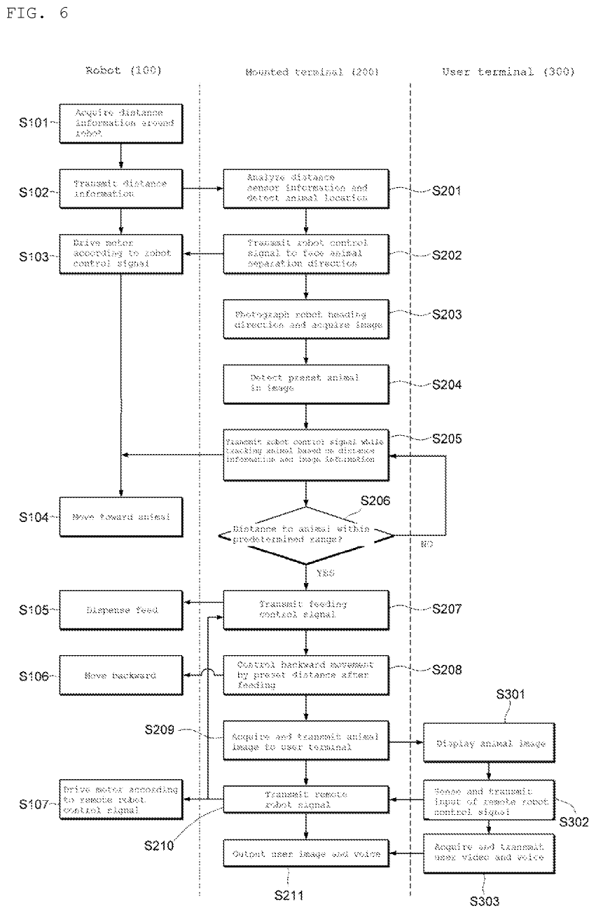

FIG. 6 is a flowchart illustrating a control method of the companion animal care system according to an embodiment of the present invention.

Referring to FIG. 6, first, the sensor unit 110 in the companion animal care robot 100 may sense environmental information around the companion animal care robot 100 (S101).

More particularly, the sensor unit 110 of the companion animal care robot 100 is an ultrasonic sensor and can measure a distance between the companion animal care robot 100 and any object around the companion animal care robot 100. Specifically, the sensor unit 110 may determine distance information to an object moving around the companion animal care robot.

Further, the distance information sensed around the companion animal care robot 100 may be transmitted to the mounted terminal 200 through the interface unit (S102).

The mounted terminal 200 receiving the distance information may analyze the same to detect a location of the companion animal (S201).

More particularly, the processor 270 may detect motion (movement) of the animal within the distance information after acquiring the distance information, and then, produce roughly (or approximately) primary animal position information including a separation direction and/or a separation distance of the animal.

Thereafter, the processor 270 may generate a control signal for movement of the companion animal care robot 100 in order to control the companion animal care robot 100, thereby enabling the companion animal care robot 100 to migrate toward a location of the animal, and then, may transmit the generated control signal to the drive motor 153 through the interface unit (S202).

More particularly, the processor 270 may transmit the companion animal care robot movement control signal in order to control the left drive motor 153L and the right drive motor 153R, respectively, thereby rotating the left wheel 151L and the right wheel 151R and changing a heading direction of the companion animal care robot 100. Consequently, it is possible to control the companion animal care robot 100 to move in the heading direction.

The drive motor 153 receiving the companion animal care robot movement control signal may rotate according to the movement control signal and spin the left wheel 151L and the right wheel 151R, so as to control the heading direction of the companion animal care robot 100 toward the animal and then move the companion animal care robot, thereby tracking the animal (S103).

Moreover, in order to more accurately track the animal, the mounted terminal 200 may acquire image information by operating the camera unit 260, while the processor 270 may analyze the image information so as to search for the animal (S203, S204).

More particularly, first, the mounted terminal 200 may approximately predict a location of the animal using the ultrasonic sensor, alter the heading direction of the companion animal care robot 100 to face the animal, and then, take picture of the animal with the front camera, thereby more accurately navigating (or searching for) the location of the animal.

Further, the processor 270 may detect the preset companion animal in the shot images (S205).

According to one embodiment, the mounted terminal 200 may analyze the images from the front camera and extract a companion animal shape included in the images, thereby tracking the companion animal.

More particularly, the processor 270 may execute segment and clustering after preprocessing of the images, and therefore, the images may be separated into background and foreground. Thereafter, the processor 270 may detect an object from the foreground separated by the image segment. Next, the processor 270 may classify the separated objects and verify the same. For instance, the processor 270 may adopt a discrimination method using a neural network, a support vector machine (SVM) technique, a discrimination method with AdaBoost using Haar-like features, histograms of oriented gradients (HOG), or the like.

According to one embodiment, the processor 270 may track the companion animal in the image by modifying a face recognition feature among the existing camera functions.

More particularly, the processor 270 may change facial image features in the face detection algorithm of a basic camera application, which is installed in the mounted terminal 200, into animal image features, so as to easily detect the companion animal from the front camera images.

According to another embodiment, after fitting an accessory (e.g., collar) having a specific image drawn thereon, which is easily detected, to the companion animal, the accessory is photographed by the front camera, and the companion animal may be easily traced by the processor 270 through the camera by detecting the specific image of the photographed accessory.

As such, the processor 270 may detect a location of an animal using the distance information received from the sensor unit 110 of the companion animal care robot 100 and the image information acquired from the image in the camera unit 260, and transmit a companion animal care robot movement control signal in order to move the companion animal care robot 100 to the detected location of the animal, thereby tracking the animal (S205). In addition, the companion animal care robot 100 may be driven according to the companion animal care robot movement control signal and then move toward the animal (S104).

Thereafter, the mounted terminal 200 may determine whether a distance to the animal reaches a predetermined distance, on the basis of the distance information and the image information (S206).

The mounted terminal 200 may transmit a feeding control signal to control the feeding module 160 if the distance to the animal is determined within a predetermined range, so as to supply the feed (S207).

More particularly, when it is time to supply the feed to the animal and the distance to the animal is within a predetermined range, the mounted terminal 200 may control the feeding module 160 to dispense the feed. That is, the mounted terminal 200 may automatically wake the companion animal care robot 100 at each set time, track a location of the companion animal, move the companion animal care robot 100 to the location, and care for the companion animal.

As mentioned above, the feeding module 160 according to the embodiment may drop the feed on the ground below the bottom surface of the companion animal care robot 100 (S105). Therefore, the feed discharged by the feeding module 160 may be hidden by a body of the companion animal care robot 100.

For instance, referring to FIG. 7, the companion animal care robot 100 and the companion animal 10 are within a predetermined distance (d), the mounted terminal 200 may control the feeding module 160 of the companion animal care robot 100 so as to drop the feed 20 under the companion animal care robot 100. Therefore, the supplied feed may be occasionally in an overlap state on the body of the companion animal care robot 100.

In this case, the animal 10 smelled the feed 20 discharged by the feeding module 160 may continuously hit the companion animal care robot 100 in order to eat the feed 20.

In order to prevent the above problem, the mounted terminal 200 may output animal training video/voice stored in the memory 240 through the display unit and the audio output unit.

More particularly, the mounted terminal 200 may output video/voice, which are stored in the memory 240 by the owner of the animal, to stop the animal and/or to instruct the animal to sit down thereby inducing the animal not to access the companion animal care robot 100.

Next, in order to expose the feed 20 to the animal, the processor 270 may generate and transmit the companion animal care robot movement control signal in order to move backward by a preset distance after dispensing the feed (S208). Further, the drive motor receiving the robot movement control signal may be driven to reverse the companion animal care robot (S106).

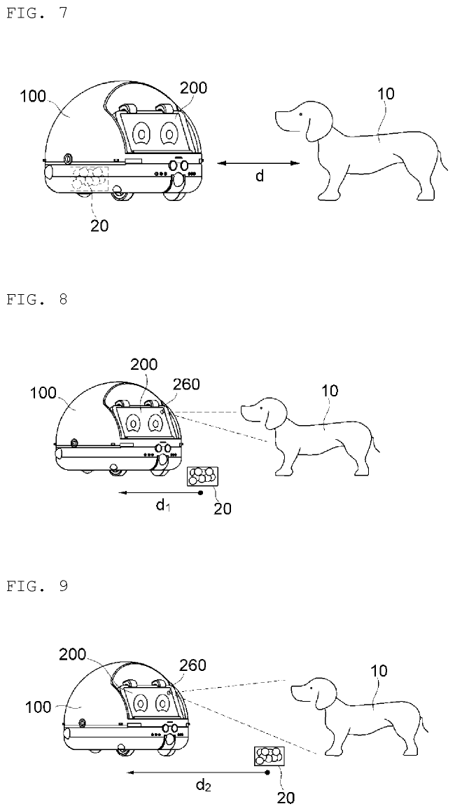

For instance, referring to FIG. 8, the processor 270 may control the robot to move backward by a first set distance (d1) and expose the feed 20, thereby exposing the feed 20 to the animal.

After exposing the feed 20, the mounted terminal 200 may control the display unit and the audio output unit in order to output the video/voice to allow food intake by the animal.

On the other hand, the mounted terminal 200 may take and capture images of food intake by the animal during intake of the feed 20 by the animal, and may transmit the captured feed intake image to the registered user terminal 600 through a communication unit 200 (S209).

The user terminal 600 receiving the feed intake video may output the same and identify companion animal care functions of the companion animal care system in real time (S301).

However, as shown in FIG. 8, if the companion animal care robot 100 moves backward by the first preset distance (d1), a figure showing that the companion animal 10 eats the feed 20 may be outside of a recording region of the camera unit 260.

If the image received from the mounted terminal 200 was photographed to show only a portion of the companion animal 10, the user may input a remote companion animal care robot control signal (‘remote control signal’) using the user terminal 600, so as to remotely control the companion animal care robot 100 to move in a desired direction or to a desired distance (S302).

More particularly, referring to FIG. 10, the remote control signal input in the user terminal 600 may be received by the mounted terminal 200 through wireless communication, and the mounted terminal 200 may transmit the received remote control signal to the moving module 150 of the companion animal care robot 100 through the interface unit, thereby further reversing the companion animal care robot 100 by a third distance (d3). Accordingly, at a location reversed by the third distance (d3), the camera unit 260 may more accurately capture video of food intake by the companion animal 10 (S210, S107).

During intake of the feed 20, when the user terminal 600 shifts the companion animal care robot backward by the third distance (d3) via the remote control signal, the processor 270 may alter and reset a backward distance travelled after subsequent supply of the feed 20 to the third distance (d3).

In other words, when the remote control signal is received from the user terminal 600 during intake of the feed 20, the mounted terminal 200 may store a distance shifted according to the remote control signal and, when the feed 20 is further supplied, may control the companion animal care robot 100 to move backward by the stored shift distance.

Accordingly, in subsequent supply of the feed 20, the mounted terminal 200 may control the companion animal care robot 100 to move to a position at which the feed intake image can be accurately captured, thereby improving user convenience.

According to another embodiment, the processor 270 may determine whether the companion animal 10 entirely comes into a shooting range by analyzing the feed intake image and, if the whole body of the companion animal 10 does not enter the shooting range, may shift the companion animal care robot 100 to move farther backward.

That is, the processor 270 may analyze the photographed image and automatically set a backward distance after supply of the feed 20.

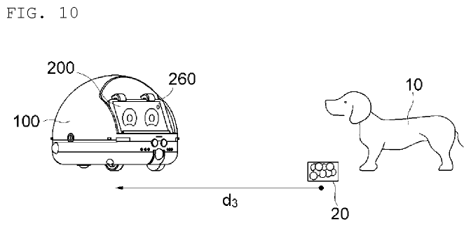

Referring to FIGS. 8 and 9, the processor 270 may continuously photograph the companion animal 10 while moving the companion animal care robot 100 backward, and may also analyze captured images to determine whether the whole body of the companion animal 10 is within the shooting range. Further, when the whole body of the companion animal 10 is photographed in the shooting range of the camera unit 260, the processor 270 may stop backward movement of the companion animal care robot 100 at a corresponding location (e.g., the backward position by a second distance (d2)) and control the camera unit 260 to capture feed intake images.

On the other hand, the processor 270 may fulfill a video call function with the user terminal 600.

More particularly, the user can transmit the video and voice to the mounted terminal 200 via the user terminal 600 (S303).

The mounted terminal 200 may output the received user video/voice and, at the same time, transmit the captured video/voice of the companion animal 10 to the user terminal, thereby fulfilling the video call function between the companion animal 10 and a master thereof (S211). That is, the companion animal care system may enable the user terminal 600 to control the mounted terminal 200 as well as the companion animal care robot 100, and may also fulfill various functions for remote communication between the companion animal 10 and the master thereof.

Further, using the companion animal care system may fulfill home care/security functions.

More particularly, the mounted terminal 200 may fulfill a home care function such that, when a sound at a level of more than predetermined decibels is generated, the mounted terminal 200 senses the sound, tracks a location causing the sound generation, controls the companion animal care robot 100 to move to the location, take pictures around the location using the camera unit 260 while rotating the companion animal care robot 100 360 degrees at the moved location, and then, transmits the taken images to the user terminal 600.

[symbol]

As described above, the present invention has been described in the detailed description with reference to preferred embodiments of the present invention. However, those having ordinary skill in the art or common knowledge in the art will appreciate that various modifications and variations may be possible in the present invention without departing from the spirit and technical scope of the present invention described in the following claims. Accordingly, the technical scope of the present invention is duly not limited to the contents described in the specification but should be defined by the appended claims.

### INDUSTRIAL APPLICABILITY

The invention provides a movable automatic feeding device, a companion animal care robot and a companion animal care system including the same, which have optimum shape and structure to contact companion animals, provide a variety of applications for managing the companion animal and can be manufactured at a low cost, thereby accomplishing industrial applicability.

[symbol]

1. A movable automatic feeding device, comprising:
a body to form an outer appearance, which includes an upper housing and a lower housing;
a terminal mounting unit formed in the upper housing;
first interface unit which is a wired port disposed near the terminal mounting unit;
a moving module provided with wheels disposed on the bottom surface of the lower housing and a drive motor to rotate the wheels;
a feeding module which includes a feed container disposed in the upper housing and a feed discharge unit to discharge feed stored in the feed container; and
a battery to supply electric power to the moving module and the feeding module.

2. The device according to claim 1, wherein the upper housing has a hemispherical cover shape having a space therein and is open at one side thereof; and wherein the lower housing has a disk cover shape and is disposed at the open side of the upper housing.

3. The device according to claim 2, wherein the lower housing has a lower edge at lateral side thereof, which is bent to the bottom and is formed in a round shape.

4. The device according to claim 1, wherein the terminal mounting unit includes a support surface formed as an inclined surface which becomes tilted inside the upper housing, and a fixing member protruding outside the support surface.

5. The device according to claim 4, wherein the terminal mounting unit further includes a tilt control member to adjust an angle of inclination (‘tilt angle’) of the support surface, and a thru-hole lens passing through the support surface.

6. The device according to claim 1, wherein the moving module includes left and right wheels protruding from the bottom surface of the lower housing, and a rotatable ball capable of rotating 360 degrees while supporting the body along with the left and right wheels.

7. The device according to claim 1, wherein the feed discharge unit of the feeding module is disposed at a feed outlet provided on the bottom surface of the lower housing, and the feed outlet is disposed to overlap at the terminal mounting unit side.

8. The device according to claim 1, wherein the battery, the moving module, the feeding module and a support member of the feed container are disposed in the lower housing.

9. A companion animal care robot, comprising:
a body to form an outer appearance;
a terminal mounting unit formed on the body to support a mounted terminal;
a first interface unit for wired communication with the mounted terminal;
a moving module to move the body;
a feeding module to discharge feed to the outside of the body;
a sensor unit to sense a distance between the body and an object placed around the body; and
a battery to supply electric power to the moving module, the feeding module and the sensor unit.

10. The robot according to claim 9, further comprising:
a circuit board connected to a wire of the first interface unit, wherein the circuit board includes wires connected to the sensor unit, the battery, the moving module and the feeding module, respectively.

11. The robot according to claim 10, wherein the first interface unit receives a robot movement control signal, the received robot movement control signal is transmitted to a drive motor of the moving module through the circuit board, and the drive motor of the moving module is driven depending on the robot movement control signal.

12. The robot according to claim 10, wherein the first interface unit receives a feeding control signal, the received feeding control signal is transmitted to a rotary motor of the feeding module through the circuit board, and the rotary motor of the feeding module is driven depending on the feeding control signal.

13. The robot according to claim 10, wherein the sensor unit includes three ultrasonic sensors which are arranged at equal intervals along an outer periphery of the body, and wherein distance information sensed by the ultrasonic sensors is gathered in the circuit board and then transmitted via the first interface unit.

14. A companion animal care robot system, comprising:
a companion animal care robot which includes a terminal mounting unit to support a terminal mounted thereon (‘a mounted terminal’), a sensor unit to sense an object placed around the robot, a moving module having wheels and a drive motor to rotate the wheels, a feeding module to discharge feed, and a first interface unit for data communication with the mounted terminal; and the mounted terminal which includes a second interface unit for data communication with the companion animal care robot, a camera unit to take pictures around the robot, and a processor that generates robot control signals to control the moving module and the feeding module while transmitting the generated signals through the second interface unit.

15. The system according to claim 14, wherein the processor: acquires the distance information, which was obtained by sensing surroundings through the sensor unit, through the second interface unit; detects a location of the companion animal based on the distance information; generates a robot movement control signal in order to move the robot to the location of the companion animal; and transmits the robot movement control signal to the moving module through the second interface unit.

16. The system according to claim 15, wherein the processor controls the camera unit to acquire a front image, and conducts image processing of the front image in order to track the companion animal contained in the front image.

17. The system according to claim 15, wherein the processor controls the feeding module to dispense the feed when the companion animal is located within a predetermined distance.

18. The system according to claim 17, wherein the processor transmits the robot movement control signal to the moving module such that the robot moves backward by a preset distance after dispensing the feed.

19. The system according to claim 18, wherein the processor acquires the front image by operating the camera unit after dispensing the feed, and transmits the acquired front image to a registered user terminal through wireless communication.

20. The system according to claim 19, wherein, when the processor receives a remote robot control signal transmitted by the user terminal, the processor transmits the remote robot control signal to the moving module or the feeding module through the second interface unit.

21. A method for controlling a companion animal care robot system, comprising:
sensing a distance to surrounding animals by a sensor unit in a companion animal care robot;
receiving information in regard to the distance to surrounding objects in a mounted terminal;
calculating a location of the animal from the distance information by the mounted terminal;
moving the companion animal care robot to the calculated location of the animal depending on control of the mounted terminal;
when a distance between the companion animal care robot and the location of the animal is within a predetermined range, dispensing feed by the companion animal care robot;
after dispensing the feed, reversing the companion animal care robot to a preset distance;
after reversing, photographing the front side to acquire front images by the companion animal care robot; and
transmitting the acquired front images to a user terminal.

22. The method according to claim 21, further comprising: photographing the front image by the camera unit of the mounted terminal, and then, executing image analysis of the front image to track the location of the companion animal.
